(19) United States
(12) Patent Application Publication
(10) Pub. No.: US 2012/0002286 A1
(43) Pub. Date: Jan. 5, 2012

(54) Optical Element and Method of Producing the Same

(76) Inventor: Yohei Tanikawa, Hino-shi (JP)

(21) Appl. No.: 13/175,179

(22) Filed: Jul. 1, 2011

(30) Foreign Application Priority Data
Jul. 2, 2010 (JP) 2010-152207

(51) Int. Cl. G02B 1/11; B29D 11/00

(52) U.S. Cl. 359/580; 264/1.1

(57) ABSTRACT

Provided is an optical element including a substrate; a plurality of pillars arranged on the surface of the substrate at a pitch equal to or less than the wavelength of incident light; a medium filling gaps between the pillars, the medium having a refractive index different from that of the pillars; and a film-like portion disposed at a position where it covers the entirety of a light-incident surface formed of at least one of the surface of the substrate, the tip surfaces of the pillars, and the surface of the medium, the film-like portion having a refractive index different from that of the pillars. The film-like portion has a film thickness such that it exhibits a reflection-preventing function realized by interference, and the volume ratio of the pillars to the medium changes in a direction along the surface of the substrate.

### CROSS REFERENCE TO RELATED APPLICATIONS

This application claims benefit of Japanese Application No. 2010-152207 filed in Japan on Jul. 2, 2010, the contents of which are hereby incorporated by its reference.

### BACKGROUND OF THE INVENTION

1. Field of the Invention

The present invention relates to an optical element and a method of producing the same.

2. Description of Related Art

In the related art, there is a known optical element having a sub-wavelength structure, in which a plurality of pillars having a uniform horizontal cross-sectional shape are arranged on the surface of a substrate, at a pitch equal to or less than the wavelength of incident light, the horizontal cross-sectional shape of the pillars being changed in a direction along the surface of the substrate (for example, see Japanese Unexamined Patent Application, Publication No. 2004-61905).

Furthermore, in the above-described optical element having a sub-wavelength structure, in order to prevent surface reflection, an optical element having tapered pillars, in which the horizontal cross-sectional shape of the pillars is continuously narrowed toward the tip, is known (for example, see Japanese Unexamined Patent Application, Publication No. 2007-47701).

However, because the refractive index drastically changes at the tip surfaces of the pillars and the surface of the substrate in the optical element disclosed in Japanese Unexamined Patent Application, Publication No. 2004-61905, incident light is reflected. Thus, the light utilization efficiency decreases.

On the other hand, in the optical element disclosed in Japanese Unexamined Patent Application, Publication No. 2007-47701, the pillars are formed in a tapered shape so as to be tapered toward the tip. With this shape, the refractive index smoothly changes at the tip surfaces of the pillars, and the incident light is not reflected. However, the refractive index drastically changes at the surface of the substrate exposed at the gaps between the pillars at the base, and thus, the incident light is reflected therefrom. Furthermore, in the optical element disclosed in Japanese Unexamined Patent Application, Publication No. 2007-47701, in which the pillars are formed in a tapered shape, a change of the horizontal cross-sectional area in a direction along the surface of the substrate becomes less significant toward the tip. Thus, the advantage of the change in the refractive index in the direction along the surface of the substrate produced by the pillars is reduced.

### BRIEF SUMMARY OF THE INVENTION

The present invention has been made in view of the above-described circumstances, and it provides an optical element and a method of producing the same, with which a change in refractive index can be efficiently produced while preventing surface reflection of the incident light.

The present invention provides an optical element including a substrate; a plurality of pillars arranged on the surface of the substrate at a pitch equal to or less than the wavelength of incident light; a medium filling gaps between the pillars, the medium having a refractive index different from that of the pillars; and a film-like portion disposed at a position where it covers the entirety of a light-incident surface formed of at least one of the surface of the substrate, the tip surfaces of the pillars, and the surface of the medium, the film-like portion having a refractive index different from that of the pillars. The film-like portion has a film thickness such that it exhibits a reflection-preventing function realized by interference, and the volume ratio of the pillars to the medium changes in a direction along the surface of the substrate.

According to the present invention, a sub-wavelength structure is formed by the plurality of pillars arranged on the surface of the substrate and the medium filling the gaps, whereby the incident light can pass therethrough without being diffracted. Moreover, by changing the volume ratio of the pillars to the medium in a direction along the surface of the substrate, the wavefront of the transmitted light can be modulated.

In this case, when the incident light passes through the film-like portion that is disposed at such a position that it covers the entirety of a light-incident surface formed of at least one of the surface of the substrate, the tip surfaces of the pillars, and the surface of the medium, the reflections at the front and back surfaces of the film-like portion are canceled by interference, whereby surface reflection is prevented. Because the surface reflection is prevented by the film-like portion provided on the entire incident surface, there is no need to employ tapered pillars for preventing reflection. Accordingly, a desired volume ratio of the pillars to the medium can be ensured over the entire pillars in the height direction, and a change in refractive index in the direction along the surface of the substrate can be efficiently produced.

In the above-described invention, it is desirable that the pillars have a substantially uniform cross-sectional shape in the direction normal to the surface of the substrate.

By doing so, a substantially uniform volume ratio of the pillars to the medium can be ensured over the entire pillars in the height direction, and the change in refractive index in the direction along the surface of the substrate can be produced most efficiently.

Furthermore, in the above-described invention, it is desirable that the film-like portion have a film thickness determined according to the change in the volume ratio of the pillars to the medium in the direction along the surface of the substrate.

By determining the film thickness according to the change in the effective refractive index due to the change in the volume ratio of the pillars to the medium in the direction along the surface of the substrate, the required reflection-preventing conditions can be met, and a preferable reflection-preventing effect can be achieved.

Furthermore, in the above-described invention, the medium may be air.

By doing so, the refractive index can be determined by the volume ratio of the pillars to the air present in the gaps between the pillars. In this case, the film-like portion may be provided on the tip surfaces of the pillars and the surface of the substrate or provided so as to cover the tip surfaces of the pillars and the surface of the medium, which is air such that it bridges between the tip surfaces of the pillars.

Furthermore, in the above-described invention, it is desirable that the medium be a solid material and be filled to a position where it forms a flat incident surface together with the tip surfaces of the pillars.

By doing so, because the gaps between the pillars are filled with the solid material, it is possible to prevent dust or the like from entering the gaps between the pillars.

Furthermore, in the above-described invention, the film-like portion may be formed as a flat film-like structure that covers the tip surfaces of the pillars and the surface of the medium.

By doing so, because the film-like portion may be disposed such that it bridges between the tip surfaces of the pillars, it is possible to simplify the production.

Furthermore, the above-described invention may include a plane parallel plate that is made of a transparent material and that covers the tip surfaces of the pillars and the surface of the medium, and the film-like portion may be provided on the surface of the plane parallel plate.

By doing so, the ease of handling can be improved, compared with a case where a single film-like portion is used.

Furthermore, in the above-described invention, the medium and the film-like portion may be integrally made of the same material.

By doing so, the medium and the film-like portion being of the same material can be easily formed.

For example, by filling the gaps between the pillars with a medium, which is composed of a flowable material that is cured after being filled, to a level where the tip surfaces of the pillars are covered and then curing the medium, the configuration can be simplified.

Furthermore, the present invention provides a method of producing the optical element, the method including a pillar forming step in which a plurality of pillars are formed on the surface of a substrate at a pitch equal to or less than the wavelength of incident light; a medium filling step in which a flowable medium having a refractive index different from that of the pillars is filled in gaps between the pillars formed in the pillar forming step to a level where the tip surfaces of the pillars are covered; and a curing step in which the medium is cured.

According to the present invention, by filling the gaps between the pillars formed on the surface of the substrate with a medium different from the pillars and curing the medium, an optical element having a sub-wavelength structure, which allows incident light to pass therethrough without being diffracted, can be easily produced. Moreover, by changing the volume ratio of the pillars to the medium in the direction along the surface of the substrate, the wavefront of the transmitted light can be modulated.

In this case, by adjusting the refractive index of the medium and the film thickness of the medium covering the tip surfaces of the pillars, this medium can be utilized as a reflection-preventing film that is disposed over the entire surface of the optical element and that exhibits a reflection-preventing function realized by interference. Accordingly, it is possible to easily produce an optical element that can ensure a desired volume ratio of the pillars to the medium over the entire pillars in the height direction and can efficiently produce a change in refractive index in the direction along the surface of the substrate.

The present invention provides an advantage in that the change in refractive index can be efficiently produced while preventing surface reflection of the incident light.

### BRIEF DESCRIPTION OF THE SEVERAL VIEWS OF THE DRAWINGS

FIG. 1 is a vertical cross-sectional view showing an optical element according to an embodiment of the present invention.

FIG. 2 is a vertical cross-sectional view schematically showing a multilayer structure equivalent to the optical element in FIG. 1.

FIG. 3 is a vertical cross-sectional view showing a first modification of the optical element in FIG. 1.

FIG. 4A is a perspective view showing the optical element in FIG. 1, which has a sub-wavelength structure extending in one dimension.

FIG. 4B is a perspective view showing the optical element in FIG. 1, which has a sub-wavelength structure extending in two dimensions.

FIG. 5 is a vertical cross-sectional view showing a second modification of the optical element in FIG. 1.

FIG. 6 is a vertical cross-sectional view schematically showing a multilayer structure equivalent to the optical element in FIG. 5.

FIG. 7 is a flowchart showing a method of producing the optical element in FIG. 5.

FIG. 8 is a vertical cross-sectional view showing a third modification of the optical element in FIG. 1.

FIG. 9 is a vertical cross-sectional view showing a fourth modification of the optical element in FIG. 1.

### DETAILED DESCRIPTION OF THE INVENTION

An optical element 1 according to an embodiment of the present invention will be described below with reference to the drawings.

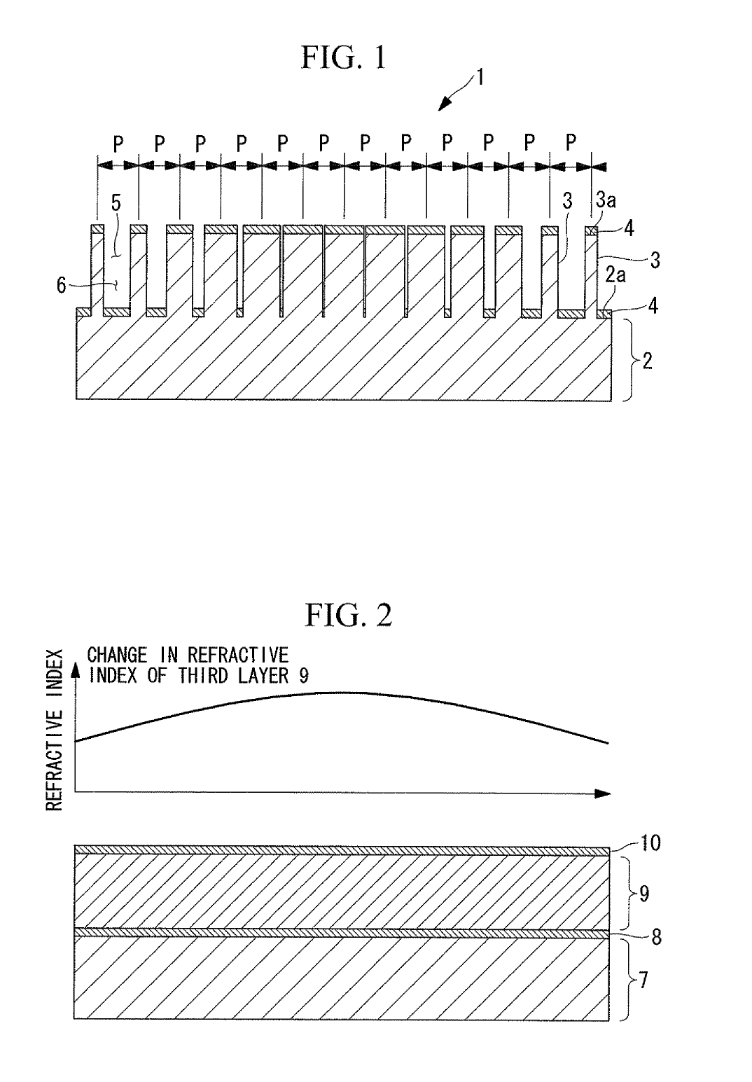

As shown in FIG. 1, the optical element 1 according to this embodiment includes a substrate 2, a plurality of pillars 3 arranged on one surface of the substrate 2, and film-like portions 4 that cover surfaces 2a of the substrate 2 and tip surfaces 3a of the pillars 3.

The pillars 3 are formed of the same material as and integrally with the substrate 2, by providing grooves in one surface of the substrate 2. The grooves may be provided using, for example, a photolithography technique.

The pillars 3 are arranged at a uniform pitch P equal to or less than the wavelength of incident light.

The horizontal cross-sectional shapes of the pillars 3 are, for example, rectangular, and the pillars 3 are formed in rectangular column shapes.

The pillars 3 are configured, for example, such that the horizontal cross-sectional areas thereof are largest at the central portion and gradually decrease toward the periphery, as shown in FIG. 4B.

The film-like portions 4 have a film thickness equal to or less than the wavelength of the incident light and are formed of a material having a refractive index different from those of the pillars 3 and the substrate 2. By selecting the film thickness and refractive index of the film-like portions 4, the film-like portions 4 serve as reflection-preventing films utilizing interference, which prevent the incident light from being reflected at the tip surfaces 3a of the pillars 3 and the surfaces 2a of the substrate 2.

The film-like portions 4 can be formed on the tip surfaces 3a of the pillars 3 and the surfaces 2a of the substrate 2 by deposition or the like.

The function of the optical element 1 having this configuration according to this embodiment will be described below.

In the optical element 1 according to this embodiment, because the pillars 3 formed on the surfaces 2a of the substrate 2 are arranged at the pitch P equal to or less than the wavelength of the incident light, a sub-wavelength structure is formed, and the incident light can pass through the optical element 1 without being diffracted.

Moreover, because air 6, serving as a medium, is present in gaps 5 between the pillars 3, the refractive index of the portion where the pillars 3 are arranged is the effective refractive index which is determined by the volume ratio of the pillars 3 to the air 6 in the gaps 5. That is, because the pillars 3 are arranged at the uniform pitch P, and because the horizontal cross-sectional areas of the pillars 3 gradually decrease from the central portion of the optical element 1 toward the periphery, the effective refractive index of the portion where the pillars 3 are arranged is also distributed so as to approach the refractive index of the air 6 starting from the refractive index of the substrate 2, from the central portion of the optical element 1 toward the periphery.

As a result, the optical element 1 according to this embodiment may be regarded as equivalent to a four-layer multilayer structure as shown in FIG. 2. Herein, a first layer 7 is the layer of the substrate 2 having a uniform refractive index, a second layer 8 is a layer of the reflection-preventing film in which the pillars 3 and the film-like portions 4 provided on the surface of the substrate 2 are disposed in the surface direction of the substrate 2 in a heterogenous manner, and in which the effective refractive index is thereby distributed, a third layer 9 is a layer in which the pillars 3 and the air 6 are disposed in a heterogenous manner in the surface direction, and in which the effective refractive index is thereby distributed, and a fourth layer 10 is a layer of the reflection-preventing film in which the air 6 and the film-like portions 4 on the tip surfaces 3a of the pillars 3 and air 6 are disposed in a heterogenous manner in the surface direction of the substrate 2, and in which the effective refractive index is thereby distributed.

That is, because the first layer 7 has a uniform refractive index, and the second layer 8 to the fourth layer 10 have sub-wavelength structures in the optical element 1 according to this embodiment, the incident light can pass therethrough without being diffracted. Furthermore, the reflection at the surface is prevented by the reflection-preventing film provided over the entire surface.

In addition, by distributing the effective refractive index of the second layer 8 to the fourth layer 10 in the surface direction, the wavefront of the transmitted light can be modulated. Moreover, forming the sub-wavelength structure from the pillars 3 having a uniform horizontal cross-sectional area provides an advantage in that a uniform effective refractive index is maintained over the overall length of the pillars 3 in the length direction, i.e., the overall length of the third layer 9 in the thickness direction, whereby the modulation of the wavefront of the light can be performed most efficiently.

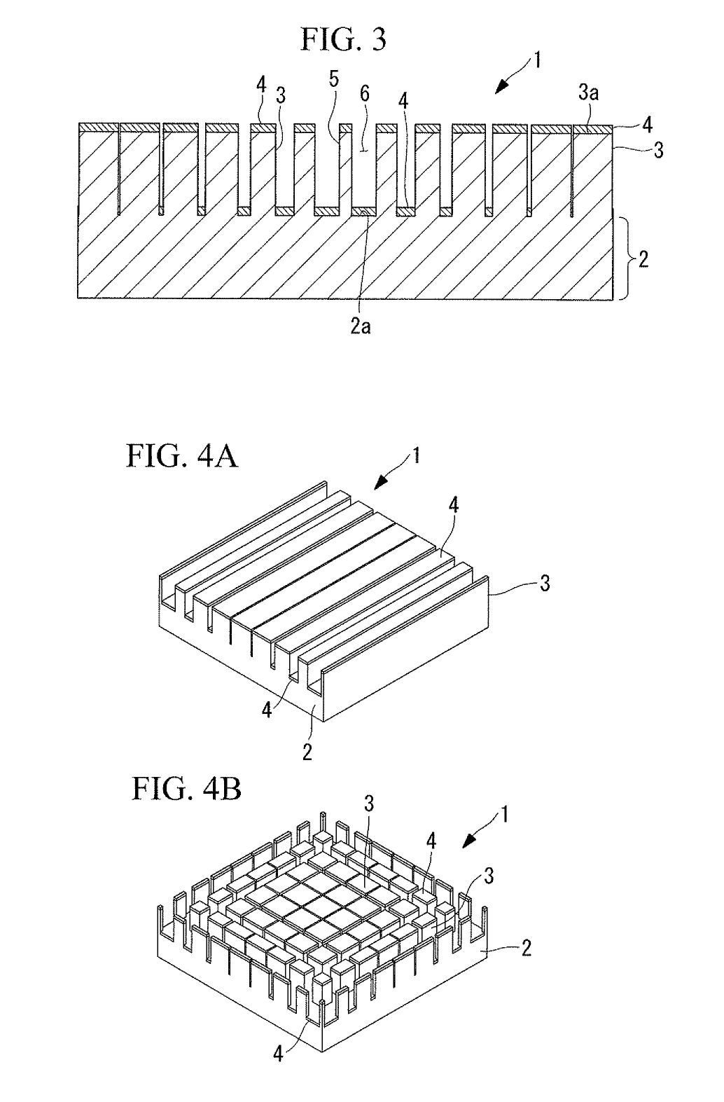

Note that, because the effective refractive index is highest at the center and gradually decreases toward the periphery in this embodiment, the optical element 1 may be used as a convex lens. However, the present invention is not limited thereto, and it may be used as a concave lens by distributing the horizontal cross-sectional areas of the pillars 3 opposite to the above, such that they are smallest at the center and gradually increase toward the periphery, as shown in FIG. 3. The distribution of the refractive index may be arbitrarily designed.

Furthermore, the optical element 1 according to this embodiment may employ either a sub-wavelength structure extending in one-dimension, as shown in FIG. 4A, or a sub-wavelength structure extending in two-dimensions, as shown in FIG. 4B.

Furthermore, although an example in which the pitch P of the pillars 3 is uniform is shown in the optical element 1 according to this embodiment, it is not limited thereto, and the pitch P may be varied in the surface direction, as long as the pitch P is equal to or less than the wavelength of the incident light and the volume ratio of the pillars 3 to the gaps 5 is varied.

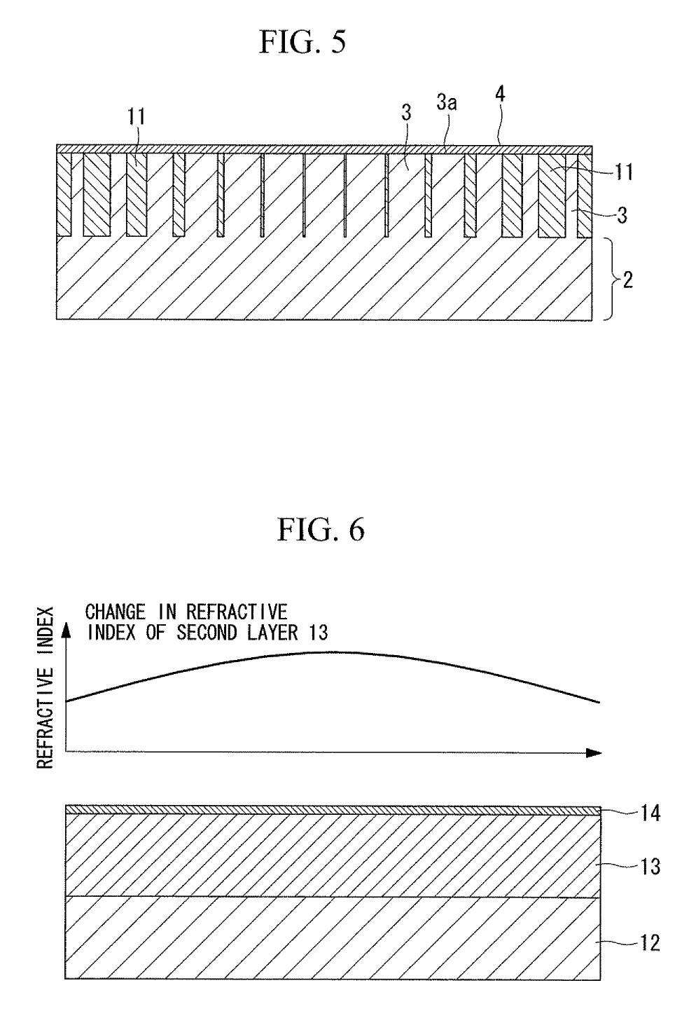

Furthermore, although an example in which the air 6 is present in the gaps 5 between the pillars 3 is shown, instead of this, as shown in FIG. 5, the gaps 5 between the pillars 3 may be filled with a solid medium 11 having a refractive index different from those of the pillars 3 and the substrate 2. In such a case, it is preferable that the surface of the medium 11 be formed so as to be flush with the tip surfaces 3a of the pillars 3 and that the film-like portions 4 be formed so as to cover the surface of the medium 11 and the entire tip surfaces 3a of the pillars 3.

By doing so, the optical element 1 equivalent to the multilayer structure as shown in FIG. 6 can be formed. This multilayer film includes a first layer 12 having a uniform refractive index; a second layer 13 having a sub-wavelength structure, in which the refractive index is distributed in the surface direction; and a third layer 14 having a uniform refractive index.

The optical element 1 having this configuration is advantageous in that it can be produced easily, because the film-like portions 4 can be formed in a flat shape. Furthermore, there is another advantage in that dust or the like is less likely to enter, because the gaps 5 are filled with the medium 11. In addition, there is another advantage in that the strength can be improved because the pillars 3 are reinforced by the medium 11.

Furthermore, the optical element 1 having this configuration can be easily produced as follows.

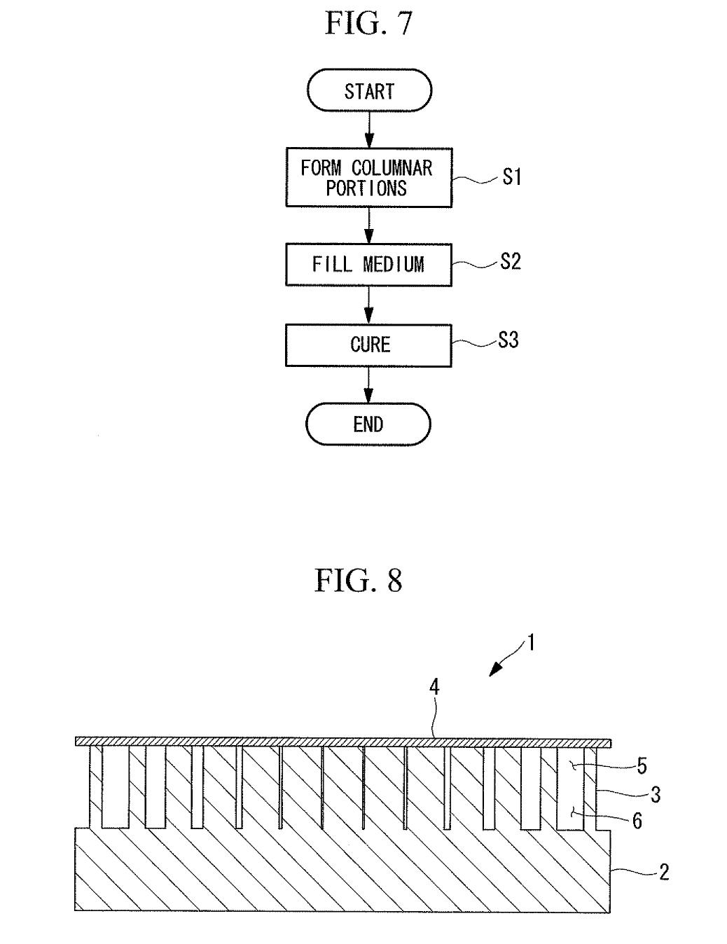

Specifically, as shown in FIG. 7, a plurality of pillars 3 are formed by providing grooves in one surface of the substrate 2 (pillar forming step S1), the flowable medium 11 having a refractive index different from that of the pillars 3 is filled in the gaps 5 between the pillars 3 to a level where the tip surfaces 3a of the pillars 3 are covered (medium charging step S2), and the flowable medium 11 is cured (curing step S3). Thus, the optical element 1 equivalent to the multilayer structure shown in FIG. 6 can be easily produced.

Furthermore, as shown in FIG. 8, the film-like portion 4 may be disposed on the entire surfaces of the tip surfaces 3a of the pillars 3 so as to bridge between them, with the gaps 5 being filled with the air 6.

Also by doing so, the optical element 1 equivalent to the multilayer film as shown in FIG. 6 can be formed.

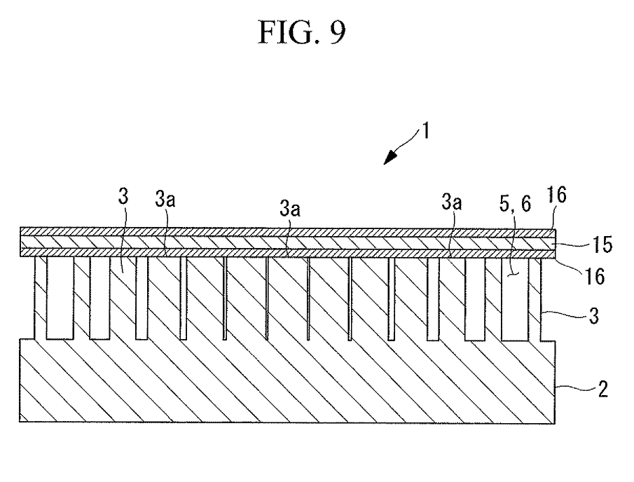

Furthermore, as shown in FIG. 9, instead of one film-like portion 4, a sheet 17, in which reflection-preventing films 16 are formed on both sides of a transparent plane parallel plate 15, may be disposed on the entire surfaces of the tip surfaces 3a of the pillars 3 so as to bridge between them. With this sheet-like structure, the ease of handling is improved compared with a case where one film-like portion 4 is disposed.

What is claimed is:

1. An optical element comprising:
a substrate;
a plurality of pillars arranged on the surface of the substrate at a pitch equal to or less than the wavelength of incident light;
a medium filling gaps between the pillars, the medium having a refractive index different from that of the pillars; and
a film-like portion disposed at a position where it covers the entirety of a light-incident surface formed of at least one of the surface of the substrate, the tip surfaces of the pillars, and the surface of the medium, the film-like portion having a refractive index different from that of the pillars, wherein
the film-like portion has a film thickness such that it exhibits a reflection-preventing function realized by interference, and
the volume ratio of the pillars to the medium changes in a direction along the surface of the substrate.

2. The optical element according to claim 1,
wherein the pillars have a substantially uniform cross-sectional shape in the direction normal to the surface of the substrate.

3. The optical element according to claim 1,
wherein the film-like portion has a film thickness determined according to the change in the volume ratio of the pillars to the medium in the direction along the surface of the substrate.

4. The optical element according to claim 1,
wherein the medium is air.

5. The optical element according to claim 1,
wherein the medium is a solid material and is filled to a position where it forms a flat incident surface together with the tip surfaces of the pillars.

6. The optical element according to claim 1,
wherein the film-like portion is formed as a flat film-like structure that covers the tip surfaces of the pillars and the surface of the medium.

7. The optical element according to claim 1, comprising a plane parallel plate that is made of a transparent material and covers the tip surfaces of the pillars and the surface of the medium,
wherein the film-like portion is provided on the surface of the plane parallel plate.

8. The optical element according to claim 1,
wherein the medium and the film-like portion are integrally made of the same material.

9. A method of producing the optical element, the method comprising:
a pillar forming process in which a plurality of pillars are formed on the surface of a substrate at a pitch equal to or less than the wavelength of incident light;
a medium filling process in which a flowable medium having a refractive index different from that of the pillars is filled in gaps between the pillars formed in the pillar forming process to a level where the tip surfaces of the pillars are covered; and
a curing process in which the medium is cured.
